(19) United States
(12) Patent Application Publication
(10) Pub. No.: US 2019/0289823 A1
(43) Pub. Date: Sep. 26, 2019

(54) PET TOY

(71) Applicant: Doskocil Manufacturing Company, Inc., Arlington, TX (US)

(72) Inventors: Jack RENFORTH, Azle, TX (US); Nicholas BAKER, Fort Worth, TX (US)

(21) Appl. No.: 16/280,133

(22) Filed: Feb. 20, 2019

Related U.S. Application Data
(60) Provisional application No. 62/645,324, filed on Mar. 20, 2018.

(51) Int. Cl. A01K 15/02; B65H 75/30

(52) U.S. Cl. CPC A01K 15/025; B65H 75/30

(57) ABSTRACT

A pet toy is basically provided with a retractable portion and a connector. The retractable portion has a housing and a cord connected to the housing. The connector has a cord attachment part and a toy attachment part. The cord attachment part is configured to be connected to an end of the cord. The toy attachment part has a hinge that pivots about a hinge axis to open and close the toy attachment part.

### CROSS-REFERENCE TO RELATED APPLICATION

This application claims priority to U.S. Provisional Application No. 62/645,324, filed Mar. 20, 2018, the contents of which are hereby incorporated herein by reference.

### BACKGROUND

### Field of the Invention

This invention generally relates to a pet toy. More specifically, the present invention relates to a pet toy having a handle and a retractable portion.

### Background Information

A pet toy can be elongated so to have a user handle at one end and a toy object attached to a cord, such as a string or chain, at another end. These types of pet toys are particularly suitable as cat toys. Moving the pet toy causes the toy object to move in a manner that will entice a cat to chase and catch the toy object. Pet toys can be retractable for easy storage and for convenient detachment of the toy object from the cord.

### SUMMARY

Generally, the present disclosure is directed to various features of a pet toy having a retractable portion.

In view of the state of the known technology and in accordance with a first aspect of the present disclosure, a pet toy is provided having a retractable portion and a connector. The retractable portion has a housing and a cord connected to the housing. The connector has a cord attachment part and a toy attachment part. The cord attachment part is configured to be connected to an end of the cord, and the toy attachment part having a hinge that pivots about a hinge axis to open and close the toy attachment part.

In accordance with a second aspect of the present invention, a pet toy is provided having a cord attachment part and a toy attachment part. The cord attachment part is configured to be connected to an end of a cord. The toy attachment part is configured to receive an interactive toy. The toy attachment part further has a hinge that pivots about a hinge axis to open and close the toy attachment part.

Also other objects, features, aspects and advantages of the disclosed pet toy will become apparent to those skilled in the art from the following detailed description, which, taken in conjunction with the annexed drawings, discloses one embodiment of the pet toy.

### BRIEF DESCRIPTION OF THE DRAWINGS

Referring now to the attached drawings which form a part of this original disclosure:

FIG. 1 is a perspective view of a pet toy in accordance with a first illustrated embodiment.

FIG. 2 is a plan view of the pet toy illustrated in FIG. 1 with the pet toy in an extended state;

FIG. 3 is a top view of a portion of the pet toy illustrated in FIGS. 1 and 2;

FIG. 4 is a plan view of a cord housing of the pet toy opened to show a retraction structure within;

FIG. 5 is an enlarged side perspective view of a connector that is part of the pet toy illustrated in FIGS. 1 to 3;

FIG. 6 is an enlarged side view of the connector of the pet toy illustrated in FIG. 5;

FIG. 7 is a cross-sectional view taken along lines 6-6 of FIG. 5;

FIG. 8 is a plan view of a cord attachment part of the connector of FIGS. 6 and 7;

FIG. 9 is a side perspective view of a pet toy in accordance with a second illustrated embodiment;

FIG. 10 is a plan view of the pet toy of FIG. 9 in an extended state;

FIG. 11 is an enlarged side perspective view of a connector that is part of the pet toy illustrated in FIGS. 9 and 10;

FIG. 12 an enlarged side view of the connector of the pet toy illustrated in FIG. 11; and

FIG. 13 is a side view of the connector of FIG. 11 opened to accept an interactive toy.

### DETAILED DESCRIPTION OF EMBODIMENTS

Selected embodiments will now be explained with reference to the drawings. It will be apparent to those skilled in the pet products field from this disclosure that the following descriptions of the embodiments are provided for illustration only and not for the purpose of limiting the invention as defined by the appended claims and their equivalents.

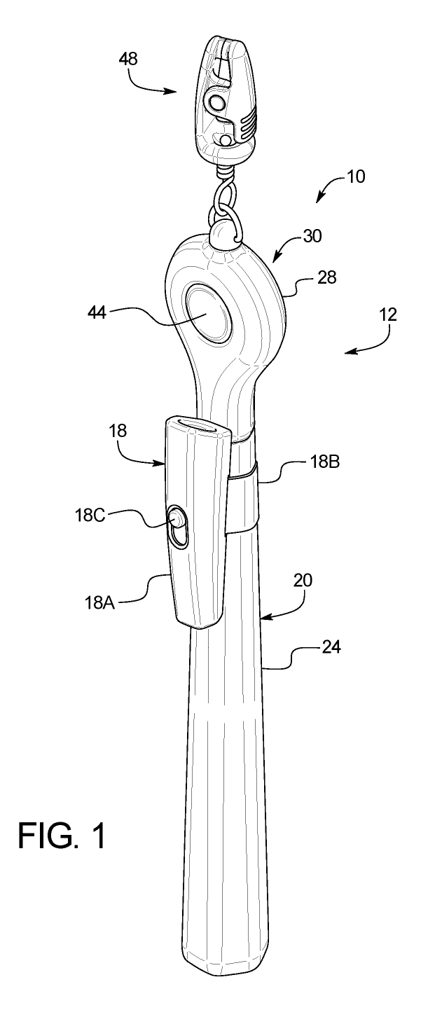

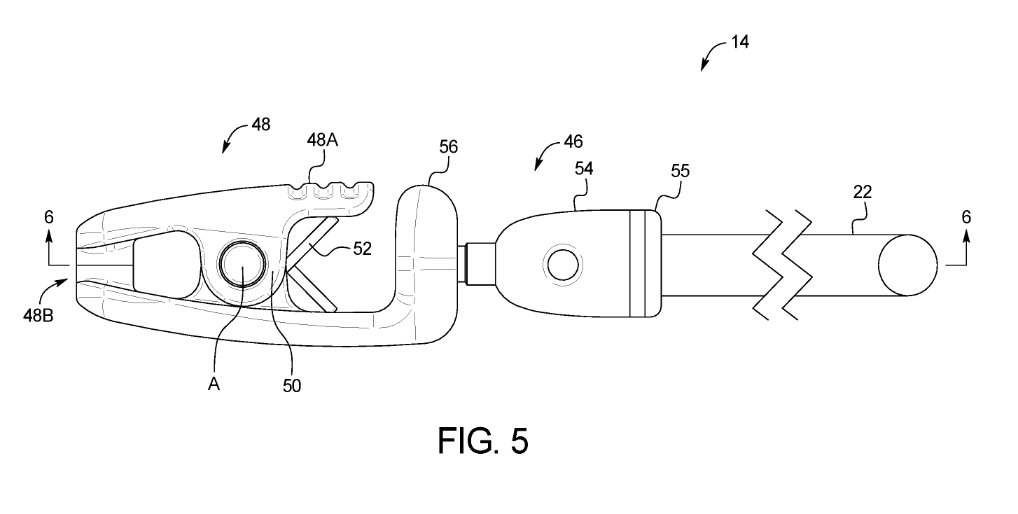

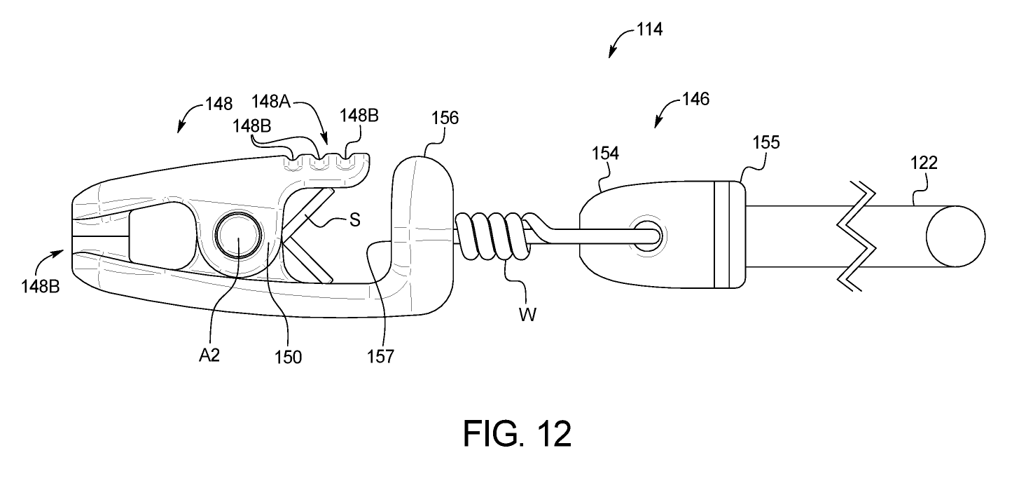

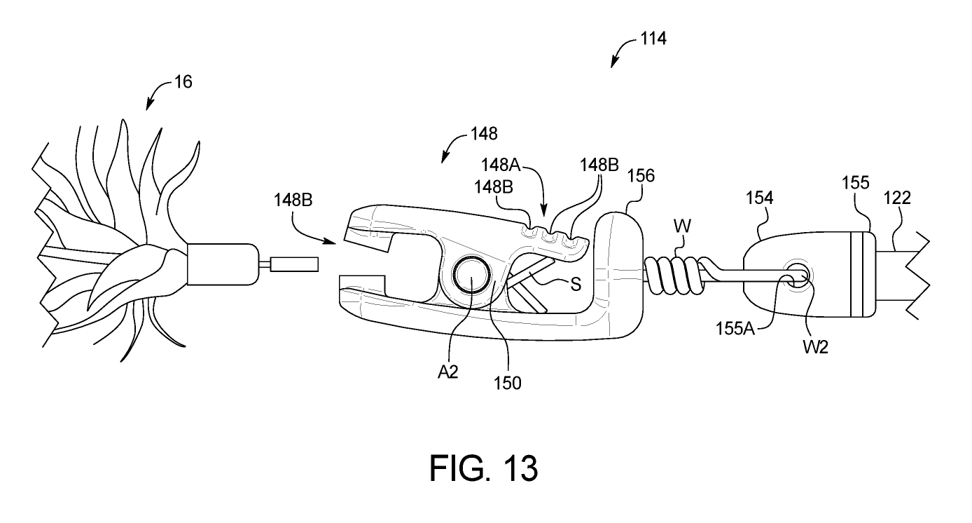

Referring now to FIG. 1, a pet toy 10 is illustrated in accordance with a first embodiment. The pet toy 10 of the first embodiment is configured to couple to an interactive pet toy 16 (see FIG. 13) that enables animal engagement with the pet toy 10. In the first embodiment, the pet toy 10 comprises a retractable portion 12 and a connector 14. Preferably, the pet toy 10 further comprises the interactive toy 16 that is detachably connected to the connector 14. For simplicity of the present application, a single interactive toy (e.g., interactive toy 16) is illustrated in FIG. 13. It will be apparent to those skilled in the pet product field from this disclosure that the interactive toy 16 can be utilized with the pet toy of FIGS. 1 through 8 or FIGS. 9 through 13. The interactive pet toy 16 can include any one of a plurality of types pet toys that a pet can directly engage with, such as a feathered toy, a stuffed animal, ribbons and/or beads, etc.

In the first embodiment, the pet toy 10 preferably further includes a laser (or light emitter) 18. The laser 18 has a laser housing 18A and an elastic band 18B. The laser 18 is configured to be removably attached to the retractable portion 12 by the elastic band 18B. Preferably, the elastic band 18B is sized to enable a snug fit onto the retractable portion 12. The laser 18 can be disposed on the retractable portion 12 at a plurality of locations along the retractable portion 12 so that the laser 18 is disposed at a preferred location for the user's use. The laser 18 can alternatively be removed from the retractable portion 12 if desired by the user. The laser 18 includes an operating switch 18C so that the user can operate the laser 18 between ON and OFF states. In this way, the pet toy 10 can entertain the pet via the interactive toy 16 and/or via the laser 18 to maintain the pet's engagement. The laser 18 is conventional and will not be further discussed herein. Although the laser 18 can be any suitable light emitter that displays a point of light on the surface of an object. It is noted that the elastic band 18B can be any suitable band and does not need to be elastic. For example, the elastic band 18B can alternatively attach the laser to the retractable portion 14 using hook and loop fasteners (e.g., Velcro®) or any suitable manner.

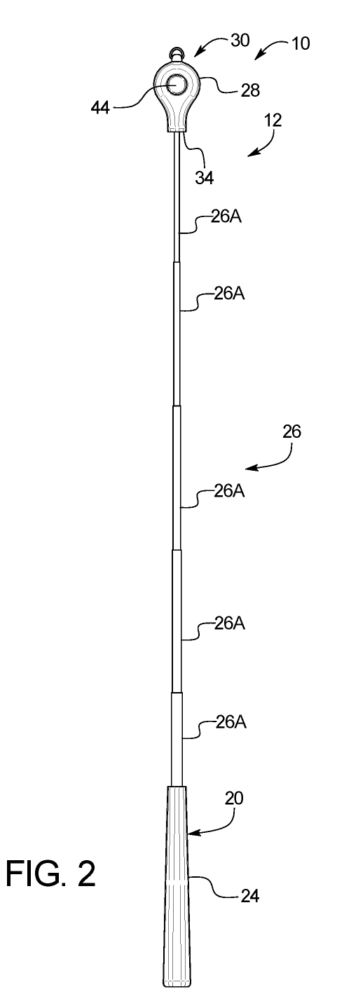

Referring to FIGS. 1 to 3, the retractable portion 12 includes a housing 20, a cord 22, a handle 24, a telescopic pole 26 and a cord housing 28. The cord 22 of the first embodiment is connected to the cord housing 28. The cord 22 is preferably made of a lightweight, non-rigid material. The cord 22 can be a string, chain or can be made of a plastic material. The cord 22 is retractable into the cord housing 28, as will be further discussed below. Preferably, the housing 20 defines the handle 24 and is hollow so that the telescopic pole 26 is retractable into the housing 20 or the handle 24 itself. The telescoping pole 26 is defined by a plurality of telescoping segments 26A that are hollow tubes having gradually decreasing diameters going from the telescoping segment nearest to the handle 24 to the telescoping segment nearest to the cord housing 28. Each one of the telescoping segments can be retracted into an adjacent telescoping segment, except for the telescoping segment nearest to the handle 24 which can be retracted into the housing 20. As best seen in FIG. 2, the telescopic pole 26 is illustrated as including five telescoping segments 26A when the telescopic pole 26 is in an expanded state. However, it will be apparent to those skilled in the pet toy field from this disclosure that the housing can include additional or fewer segments of the telescopic pole 26 by modifying the telescopic pole 26 as needed and/or desired.

Referring to FIGS. 1 and 2, the handle 24 is preferably made of a rigid and non-deformable material, such as hard plastic, to prevent animals from chewing and deforming the handle 24. Preferably, the handle 24 is made of molded acrylonitrile butadiene styrene (ABS) or other thermoplastic polymer that is tough and impact resistant. In the first illustrated embodiment, the handle 24 has a textured surface for better user grip. For example, handle 24 preferably includes a matte finish for user grip. However, the handle 24 can be formed from any suitable or desired material.

As previously stated, the telescopic pole 26 is retractable into the handle 24. The telescopic pole 26 is illustrated as including five telescoping segments 26A that are rigid. Also, as previously stated, the telescopic pole 26 can be modified to include additional or fewer telescoping segments 26A, as needed and/or desired. In the first embodiment, the telescopic pole 26 is made of metal and preferably made of steel. The telescopic pole 26 can alternatively be made of plastic or any other suitable or desired material.

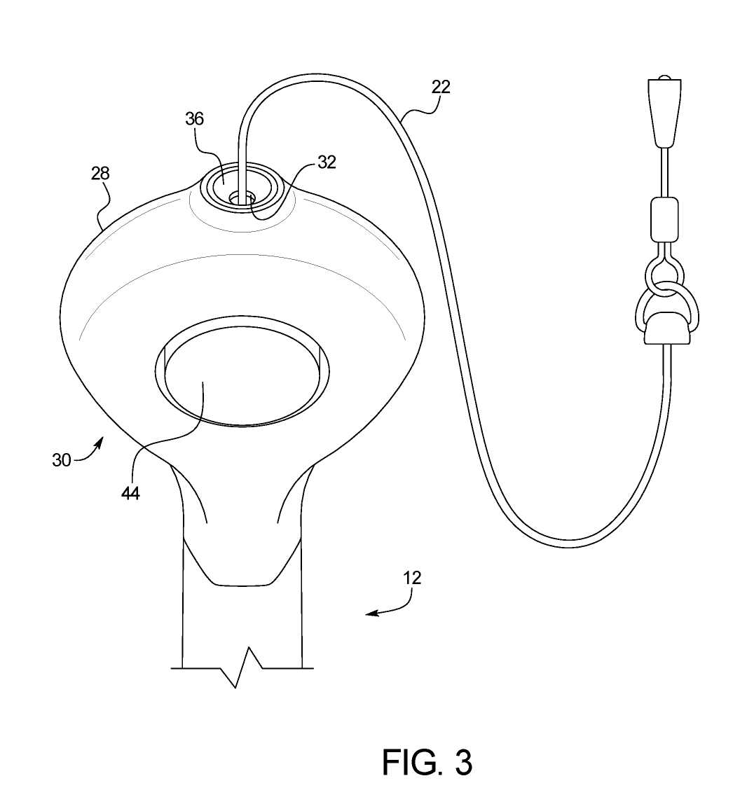

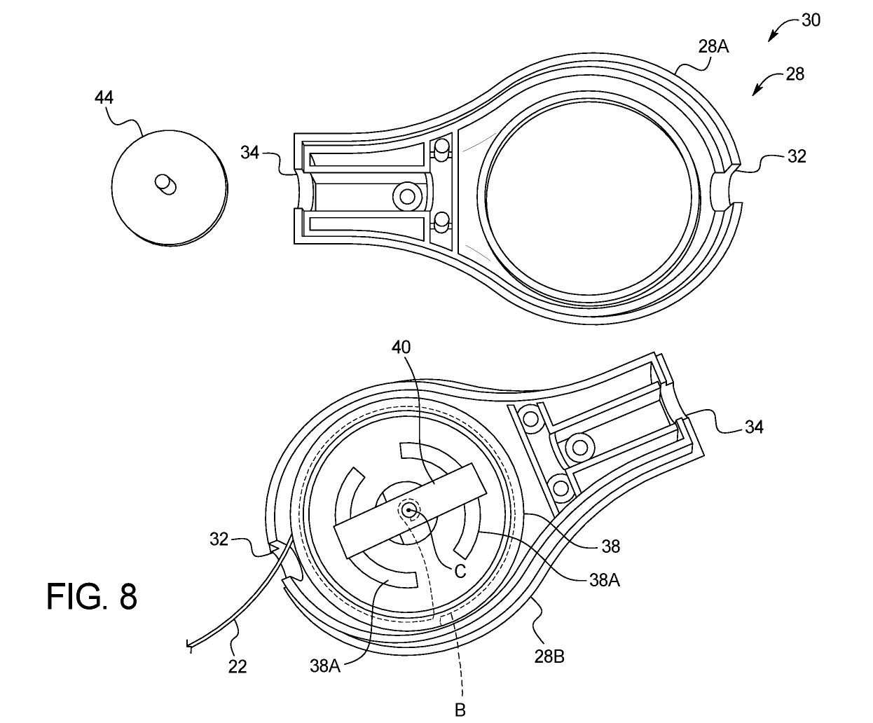

Referring to FIGS. 3 and 8, the cord housing 28 will now be discussed. In the illustrated embodiment, the cord housing 28 is also made of a rigid, lightweight material that is similar to the handle 24. In the illustrated embodiment, the cord housing 28 is made of a similar hard plastic material to the handle 24 and includes a gloss finish. The cord housing 28 includes a pair of housing parts 28A and 28B that are mated to house a retraction mechanism 30 for retracting the cord 22 into the cord housing 28. The cord housing 28 includes a first opening 32 for receiving the cord 22 into the cord housing 28, and a second opening 34 that operatively receives an end of the telescopic pole 26. Preferably, the cord housing 28 includes a metallic end piece 36 disposed over the first opening 32. The metallic end piece 36 is made of chrome metal to protect the cord 22 from rubbing against plastic of the cord housing 28 when the cord 22 is retracted and extended from the cord housing 28.

The cord housing 28 houses a gear 38 having plurality of teeth 38A, a pawl 40 and a biasing spring B (shown in dashed lines in FIG. 8). The cord housing 28 further houses an actuation button 44 of the retraction mechanism 30. The biasing spring B is wound about a center axle C of the cord housing 28 to bias the retraction mechanism 30 into a retracted state in a conventional manner. Preferably, the center axle C is an axle of the pawl 40. In other words, biasing spring B biases the retraction mechanism 30 to retract the cord 22 into the cord housing 28. For example, a first end of the biasing spring B can be attached to one of the housing parts 28A and 28B, and a second end of the biasing spring B is connected to the center axle C of the pawl 40. The biasing spring can be an elongated metal strip that acts as a constant force spring.

The retraction mechanism 30 further includes the actuation button 44 operatively connected to the pawl 40 to operate the pawl 40 into and out of engagement with the gear 38. When the user operates the actuation button 44, the pawl 40 is moved out of engagement with the gear 38 such that the cord 28 is retracted into the cord housing 28. The cord 22 is operatively connected to the gear 38 so that the cord 22 is wrapped around the gear 38 when retracted into the cord housing 28. The pawl 40 ratchets against the teeth 38A of the gear 38 when the cord 22 is extended from the cord housing 28 so that the cord 22 is extended from the cord housing 28 in a controlled manner. For example, when the pet tugs upon the cord 22 when playing with the interactive toy 16, the cord 22 can extend from the cord housing 28 until the user actuates the actuation button 44. Upon actuation of the actuation button 44, the pawl 40 is pushed out of engagement with the gear 38 so the biasing spring causes the gear 38 to retract the cord 22.

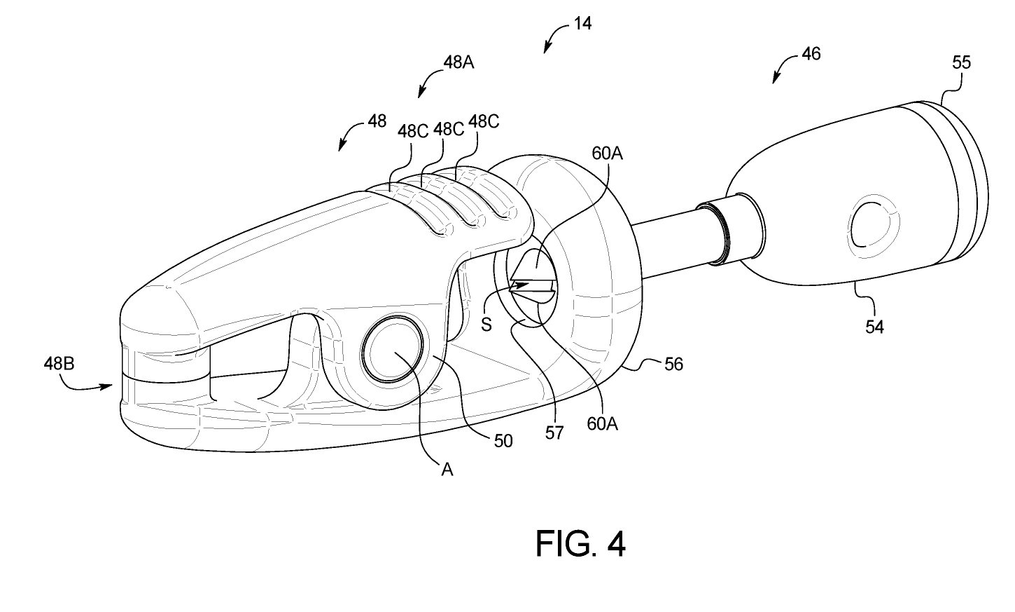

The connector 14 will now be discussed with reference to FIGS. 4 to 7. The connector 14 is preferably made of a rigid, lightweight material such as a hard plastic. The connector 14 can alternatively be made of wood or metal or any other suitable material. The connector 14 has a cord attachment part 46 and a toy attachment part 48. As shown, the toy attachment part 48 includes a user operating portion 48A and a gripping portion 48B that is configured to grip the interactive toy 16. In the illustrated embodiment, the user operating portion 48A includes a plurality of grooves 48C to enhance user contact. The user operating portion 48A is operable about a hinge 50 to open and close the gripping portion 48B to accept or release an interactive toy. Thus, the toy attachment part 48 includes the hinge 50 that pivots about a hinge axis A to open and close the toy attachment part 48. A user pushes and releases the user operating portion 48A to open and close the gripping portion 48B, which acts like a clip to detachably receive or release the interactive toy 16. The connector 14 further includes a biasing spring (not shown) disposed about the hinge axis A. The biasing spring biases the connector 14 into a closed position. Preferably, the biasing spring is a torsion spring that is disposed around the hinge axis A.

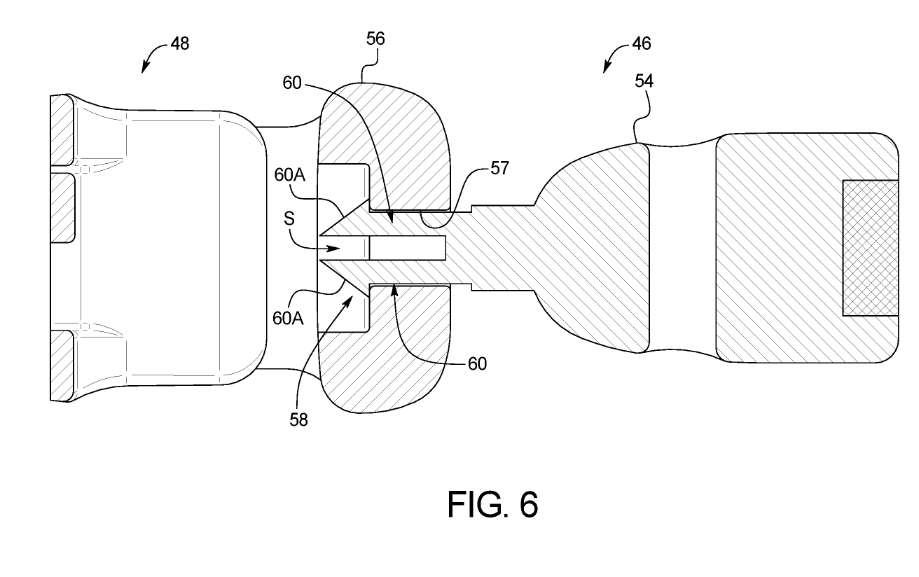

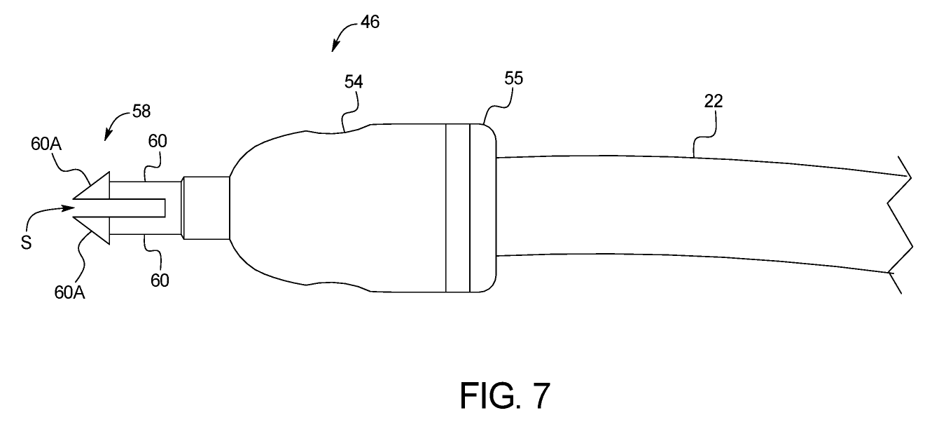

As shown in FIGS. 6 and 7, the cord attachment part 46 is configured to be connected to an end of the cord 22. In particular, the cord attachment part 46 includes a first section 54 and a second section 56. The first and second sections 54 and 56 are movably connected, as discussed below. The first section 54 includes an end mount 55 that is directly connected to the cord 22 in a conventional manner. The second section 56 is integral with the toy attachment part 48. As best seen in FIGS. 6 and 7, the first section 54 includes an end mount 55 that is fixedly attached to the cord 22 in a conventional manner. The first section 54 further includes an inclined insertion part 58. In the illustrated embodiment, the inclined insertion part 58 includes a pair of barbed extensions 60 having inclined surfaces 60A. The second section 56 includes a receiving hole 57. The inclined insertion part 58 of the first section 54 is detachably received into the receiving hole 57 of the second section 56.

Preferably, the first and second sections 54 and 56 are connected by a snap-fit connection. Thus, when coupling first and second section, the barbed extensions 60 of the inclined insertion part 58 are inserted into the receiving hole 57. The inclined surfaces 60A causes the barbed extensions 60 to be deformed toward each other upon insertion into the receiving hole 57. The barbed extensions 60 of the inclined insertion part 58 remain deformed toward each other to enable the inclined insertion part 58 to pass through the receiving hole 57. As the shoulders of the barbed extensions 60 pass through the receiving hole 57, the barbed extensions 60 “spring” back to their original configuration, enabling the inclined insertion part 58 to snap fit to and engage the second section 56.

Thus, as seen in the FIG. 6, the second section 56 receives the inclined surfaces 60A of the barbed extensions 60 when the first and second sections 54 and 56 are attached. The barbed extensions 60 are separated by a slot S such that the inclined surfaces 60A can be deformed towards each other under a predetermined force during when received in the receiving hole 57. Therefore, under a predetermined force (e.g., when the pet tugs the cord 22 with enough force) the barbed extensions 60 can be inclined towards each other to exit from the receiving hole 57 and separate from the second section 56. Thus, the first and second sections 54 and 56 of the cord attachment part 46 can detach under a predetermined force. This detachability prevents possible breakage of the connector 14 due to an animal tugging on the interactive toy 16.

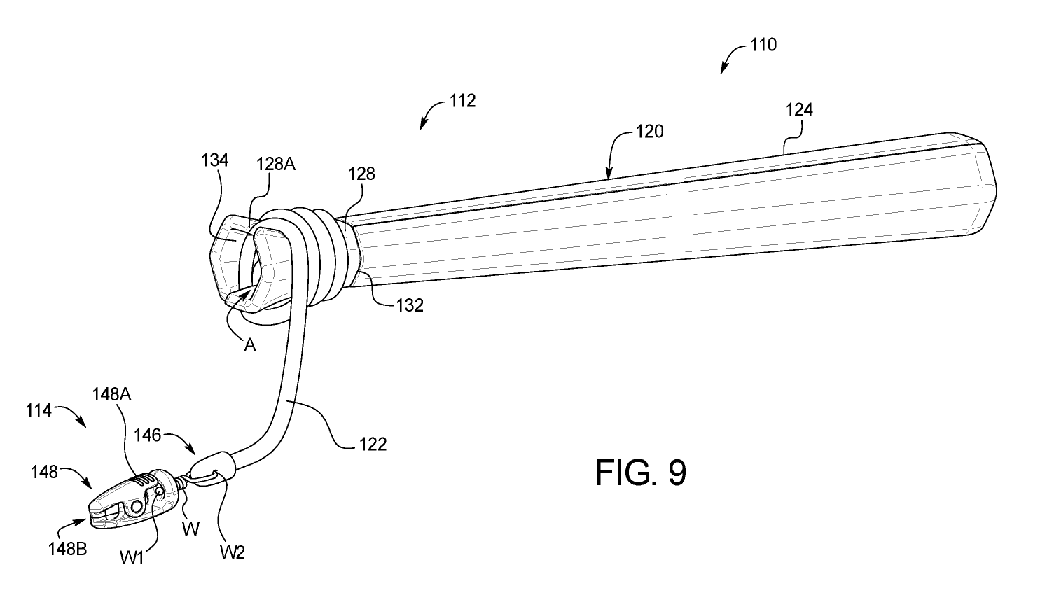

Referring now to FIGS. 9 to 13, a pet toy 110 in accordance with a second illustrated embodiment will now be discussed. Similar to the pet toy 10, the pet toy 110 of the second illustrated embodiment comprises a retractable portion 112 and a connector 114. The retractable portion 112 includes a housing 120 that includes a user handle 124 and houses a telescopic pole 126. Preferably, the pet toy 110 further comprises an interactive toy such as the interactive toy 16 which is detachably connected to the connector 114, and a cord 122 that is detained on the retractable portion 112. As with the pet toy 10, the interactive pet toy 16 can include any one of a plurality of pet toys, such as a feathered toy, a stuffed animal, ribbons and/or beads. Due to the similarity of the pet toys 10 and 110, all corresponding components of the pet toy 110 will receive the same reference numeral plus 100 with respect to the pet toy 10.

The pet toy 110 of the second illustrated embodiment is similar to the pet toy 110 of the first illustrated embodiment except that the retractable portion 112 now includes the telescopic pole 126 and a deformable cord receiver 128 in place of a cord housing. In the pet toy 110, the cord 122 is not retractable but is wrapped around the deformable cord receiver 128 to stow the cord 122, as will be discussed below. One end of the cord 122 is fixedly secured to the deformable cord receiver 128. In particular, the cord 122 preferably is knotted at one end (not shown) which is received in an interior hole (not shown) of the deformable cord receiver 128 to secure the cord 122 to the deformable cord receiver 128. The cord 122 of the second illustrated embodiment is preferably thicker than the cord 22 of the first illustrated embodiment. For example, the cord 122 is made of fabric such as nylon or polyester. The cord 122 can alternatively be made of any type of appropriate flexible material. The telescopic pole 126 includes a plurality of telescoping segments 126A that are retractable into the housing 120. The cord 122 is conventional and will not be further discussed herein.

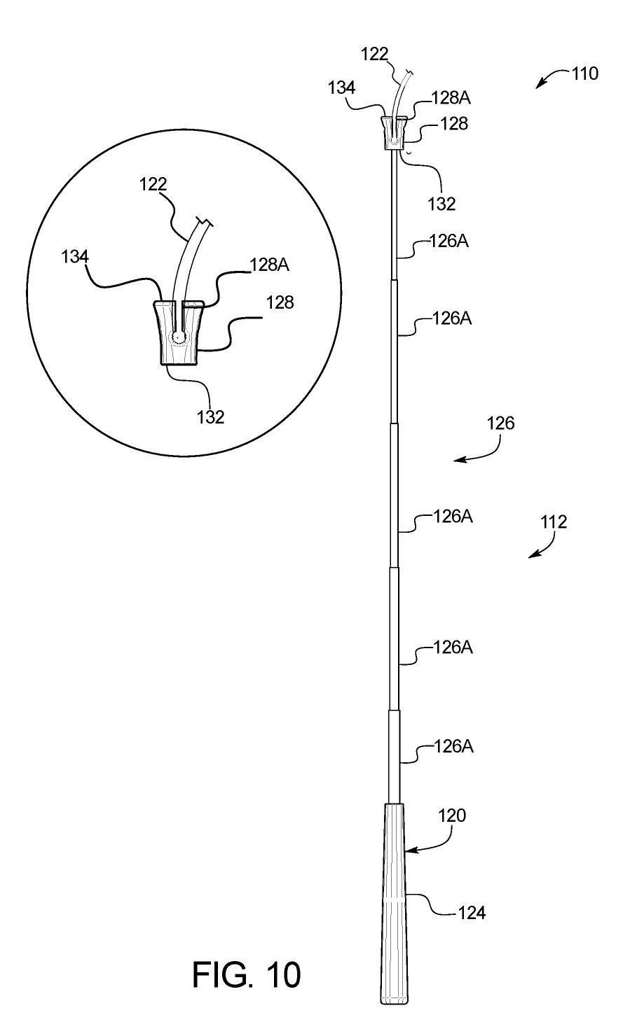

Referring to FIGS. 9 and 10, the housing 120 includes the cord receiver 128 which is attached to an end of the telescopic pole 126. In particular, the cord receiver 128 has a first opening 132 that receives the end of the telescopic pole 126 therethrough and a second opening 134 for receiving the cord 122. As best seen in FIG. 9, the cord 122 is fixedly attached to the end of the telescopic pole 126. In the second illustrated embodiment, the cord receiver 128 is a tubular member having a cord receiving area A that receives the cord 122. In particular, the cord 122 can be wrapped around the exterior of the cord receiving area A. The cord receiving area A includes a receiving slot 128A defining a space having a bulged end that receives and stows the wrapped cord 122. In the second illustrated embodiment, the cord receiver 128 is preferably made of a deformable material, such as thermoplastic rubber.

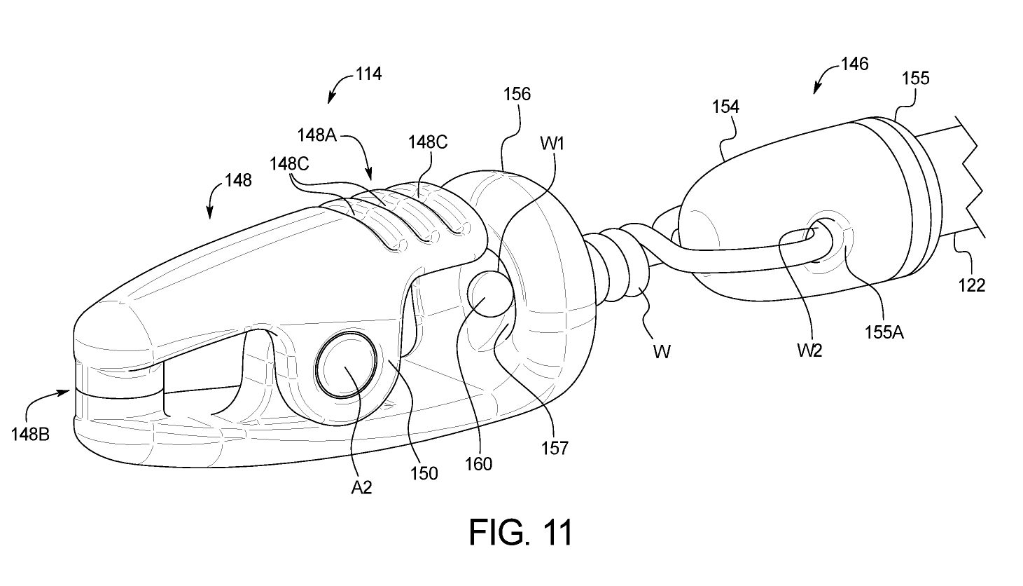

Referring to FIGS. 11 to 13, the connector 114 of the second illustrated embodiment is similar to the connector 14 of the first illustrated embodiment, except that the connector 114 of the second illustrated embodiment is not configured to be detachable from the cord 122 under the same predetermined force as was discussed in the first illustrated embodiment. Rather, the connector 114 is configured to remain fixed to the cord 122 when the pet tugs on the cord 122 with force. The connector 114 includes a cord attachment part 146 and a toy attachment part 148.

As shown, the toy attachment part 148 includes a user operating portion 148A and a gripping portion 148B. The user operating portion 148A includes a plurality of grooves 148C to enhance user contact. The user operating portion 148A is operable about a hinge 150 to open and close the gripping portion 148B to accept or release the interactive toy 16. In particular, the toy attachment part 148 acts as a clip that can be clipped to the interactive toy 16, as seen in FIG. 13. The connector 114 further includes a biasing spring S disposed about the hinge axis A2. The biasing spring S biases the connector 114 into a closed position. Preferably, the biasing spring S is a torsion spring that is disposed around the hinge axis A2.

The cord attachment 146 part includes a first section 154 and a second section 156 that are movably connected to each other. In particular, the first and second sections 154 and 156 are rotatably connected to each other such that the first and second sections 154 and 156 are rotatable with respect to each other. The first section 154 includes an end mount 155 that is directly connected to the cord 122. The second section 156 is integral with the toy attachment part 148. In the second illustrated embodiment, the connector 146 is a rotatable connector such that the first and second sections 154 and 156 can swivel with respect to each other.

As shown, the first and second sections 154 and 156 are connected by a thick wire W enabling free rotation of the first and second sections 154 and 156 relative to each other. Preferably, the wire W is formed by a rigid, durable material. Preferably, the wire W is made of metal, but can be made of any suitable material. A first end W1 of the wire W is inserted through a receiving hole 157 of the second section 156. The wire W is secured therein by a bulbous end 160 of the wire W disposed at the first end W1. A second end W2 of the wire W is fixedly connected to the first section 154. As shown, the second end W2 of the wire W is formed by portion that is inserted through a through hole 155A of the end mount 155. As the wire W can be rotatable with respect to the second section 156 when the wire W is inserted into the receiving hole 157, the first and second sections 154 and 156 is rotatable with respect to each other.

In understanding the scope of the present invention, the terms “part,” “section,” “portion,” “member” or “element” when used in the singular can have the dual meaning of a single part or a plurality of parts unless otherwise stated.

Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet toy comprising:
a retractable portion having a housing and a cord connected to the housing; and
a connector having a cord attachment part and a toy attachment part, the cord attachment part being configured to be connected to an end of the cord, the toy attachment part having a hinge that pivots about a hinge axis to open and close the toy attachment part.

2. The pet toy according to claim 1, wherein
the connector includes a biasing spring disposed about the hinge axis, the biasing spring biasing the connector into a closed position.

3. The pet toy according to claim 1, wherein
the cord attachment part includes a first section that is movably connected to a second section, the first section being directly connected to the cord and the second section being integral with the toy attachment part.

4. The pet toy according to claim 3, wherein
the first and second sections are connected by a wire enabling free rotation of the first and second sections relative to each other.

5. The pet toy according to claim 3, wherein
first section includes an inclined insertion part and the second section includes a slot, the inclined insertion part of the first section being detachably received into the slot of the second section.

6. The pet toy according to claim 5, wherein
the inclined insertion part includes a pair of barbed extensions.

7. The pet toy according to claim 5, wherein
the first and second sections are connected by a snap-fit connection.

8. The pet toy according to claim 1, wherein
the housing includes a handle and a telescopic pole that is retractable into the handle.

9. The pet toy according to claim 8, wherein
the housing further includes a cord housing, the cord being retractable into the cord housing.

10. The pet toy according to claim 9, wherein
the cord housing having an actuation button, the cord being retracted into the cord housing upon actuation of the actuation button.

11. The pet toy according to claim 8, wherein
the housing further includes a deformable cord receiver attached to an end of the telescopic pole, the cord receiver having a pair of receiving slots that receive the cord.

12. The pet toy according to claim 1, further comprising
a laser having a laser housing and an elastic band, the laser configured to be removably attached to the retractable portion by the elastic band.

13. The pet toy according to claim 1, further comprising
an interactive toy that is detachably connected to the toy attachment part of the connector.

14. A pet toy connector comprising:
a cord attachment part and a toy attachment part, the cord attachment part being configured to be connected to an end of a cord, the toy attachment part being configured to receive an interactive toy, the toy attachment part further having a hinge that pivots about a hinge axis to open and close the toy attachment part.

15. The pet toy connector according to claim 14, further comprising
a biasing spring disposed about the hinge axis, the biasing spring biasing the pet toy connector into a closed position.

16. The pet toy connector according to claim 14, wherein
the cord attachment part includes a first section that is movably connected to a second section, the first section being configured to be directly connected to the cord and the second section being integral with the toy attachment part.

17. The pet toy connector according to claim 16, wherein
the first and second sections are connected by a wire enabling free rotation of the first and second sections relative to each other.

18. The pet toy connector according to claim 16, wherein
first section includes an inclined insertion part and the second section includes a slot, the inclined insertion part of the first section being detachably received into the slot of the second section.

19. The pet toy connector according to claim 17, wherein
the inclined insertion part includes a pair of barbed extensions.

20. The pet toy connector according to claim 16, wherein
the first and second sections are connected by a snap-fit connection.
